(19) United States
(12) Patent Application Publication
(10) Pub. No.: US 2026/0128002 A1
(43) Pub. Date: May 7, 2026

(54) TRAINING SYSTEM, TRAINING METHOD, DIMMING SYSTEM, DIMMING METHOD, COMPUTER-READABLE RECORDING MEDIUM WITH STORED PROGRAM, AND NON-TRANSITORY COMPUTER PROGRAM PRODUCT

(71) Applicant: REALTEK SEMICONDUCTOR CORP., Hsinchu (TW)

(72) Inventor: Cheng-Chun Wang, Hsinchu (TW)

(73) Assignee: REALTEK SEMICONDUCTOR CORP., Hsinchu (TW)

(21) Appl. No.: 19/366,724

(22) Filed: Oct. 23, 2025

(30) Foreign Application Priority Data
Nov. 4, 2024 (TW) 113142193

(51) Int. Cl. G09G 3/32; G06N 3/045; G06N 3/0464; G06T 5/60; G06T 5/92; G09G 3/34

(52) U.S. Cl. CPC G09G 3/32; G06N 3/045; G06N 3/0464; G06T 5/60; G06T 5/92; G09G 3/3413; G06T 2207/10024; G06T 2207/20081; G06T 2207/20084; G09G 2320/0646; G09G 2320/0673; G09G 2360/16

(57) ABSTRACT

A training system, a training method, a dimming system, a dimming method, a computer-readable recording medium with a stored program, and a non-transitory computer program product are provided. The training method is used for training a to-be-trained neural network module and is performed by a processing module. The to-be-trained neural network module includes a target image generation module, a to-be-trained neural network, and a light distribution generation module. The training method includes: performing the following steps in one training epoch: repeatedly performing: using a training image in a training set as an input image, performing a convolution operation on an intermediate compensation image of the training image and light distribution to generate a convolutional image, and obtaining a loss based on the convolutional image and a target image; and updating a plurality of parameters based on an average of all losses obtained in the foregoing step and an updated algorithm.

### CROSS-REFERENCE TO RELATED APPLICATION

This non-provisional application claims priority under 35 U.S.C. § 119(a) to Patent Application No. 113142193 filed in Taiwan, R.O.C. on Nov. 4, 2024, the entire contents of which are hereby incorporated by reference.

### BACKGROUND

### Technical Field

The present invention relates to the dimming field, and in particular, to a technology of applying a neural network to dimming.

### Related Art

In a current local dimming system, a process roughly includes first performing backlight decision. A backlight source intensity of each block may be decided upon algorithm design, sometimes may be decided upon a maximum pixel, or sometimes may be decided upon an average pixel. Then, light spread modeling is performed. Light distribution of backlight is calculated based on the backlight source intensity. Then, pixel compensation is performed. Pixels are adjusted based on the backlight source intensity to maintain image stability. In an ideal situation, image contrast is enhanced in this manner. The backlight adjustment and the corresponding pixel compensation have some problems. First, in some low-brightness scenarios, because the pixel compensation is to calculate an amount to be compensated through local backlight, a black side may be caused in a conventional manner. In addition, the pixel compensation is decided based on the local backlight. A concept of depth of field is lacking in this process. As a result, a farther image has a darker surface, resulting in a poor depth-of-field effect.

### SUMMARY

In view of this, some embodiments of the present invention provide a training system, a training method, a dimming system, a dimming method, a computer-readable recording medium with a stored program, and a non-transitory computer program product, to eliminate the current technical problems.

Some embodiments of the present invention provide a training system, including a processing module and a to-be-trained neural network module. The to-be-trained neural network module includes: a target image generation module, configured to receive an input image and obtain a target image based on a target calculation procedure; a to-be-trained neural network having a plurality of parameters, and the to-be-trained neural network being configured to generate an intermediate compensation image based on the input image and the parameters; and a light distribution generation module, configured to generate light distribution based on the input image. The processing unit is configured to perform the following steps in one training epoch: repeatedly performing the following operations: using a training image in a training set as the input image; performing a convolution operation on the intermediate compensation image of the training image and the light distribution to generate a convolutional image; and obtaining a loss based on the convolutional image and the target image; and updating the parameters based on an average of all losses obtained in the foregoing step and an updated algorithm.

Some embodiments of the present invention provide a training method, used for training a to-be-trained neural network module and performed by a processing module. The to-be-trained neural network module includes: a target image generation module, configured to receive an input image and obtain a target image based on a target calculation procedure; a to-be-trained neural network having a plurality of parameters, and the to-be-trained neural network being configured to generate an intermediate compensation image based on the input image and the parameters; and a light distribution generation module, configured to generate light distribution based on the input image. The training method includes performing the following steps in one training epoch: repeatedly performing the following operations: using a training image in a training set as the input image; performing a convolution operation on the intermediate compensation image of the training image and the light distribution to generate a convolutional image; and obtaining a loss based on the convolutional image and the target image; and updating the parameters based on an average of all losses obtained in the foregoing step and an updated algorithm.

Some embodiments of the present invention provide a dimming system. The dimming system includes a dimming system backlight decision module and a neural network module; The backlight decision module of the dimming system is configured to receive an image and generate a plurality of backlight source intensities of the image based on the image. The neural network module includes a neural network, the neural network is configured to have a same architecture as the to-be-trained neural network, and the neural network module is configured to store parameters obtained by the training system through training, and is configured to receive an image, and generate a compensation image of the image based on the neural network and the parameters.

Some embodiments of the present invention provide a dimming method, including: receiving an image and generating a plurality of backlight source intensities of the image based on the image by a dimming system backlight decision module; and receiving the image and generating a compensation image of the image based on a neural network and parameters obtained by using the foregoing training method through training by a neural network module, where the neural network has a same architecture as a to-be-trained neural network.

Some embodiments of the present invention provide a computer-readable medium with a stored program and a non-transitory computer program product. After the program is loaded and executed by a processing unit, the foregoing training method can be completed.

Based on the above, according to the training system, the training method, the dimming system, the dimming method, the computer-readable recording medium with a stored program, and the non-transitory computer program product provided in some embodiments of the present invention, the loss obtained based on the convolutional image and the target image is considered in a model training process, so that an image generated by a trained neural network may have a desired effect (for example, a 3D-like depth-of-field effect) when being displayed on a display. Using the neural network to generate the compensation image in the dimming system can also make a compensation process faster.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a training system according to an embodiment of the present invention;

FIG. 2A is a schematic flowchart of a training method according to some embodiments of the present invention;

FIG. 2B is a schematic diagram of a convolutional image according to some embodiments of the present invention;

FIG. 2C is a schematic diagram of a target image according to some embodiments of the present invention;

FIG. 3 is a block diagram of a target image generation module according to some embodiments of the present invention;

FIG. 4A and FIG. 4B are schematic diagrams of an input image and an output image of a MiDaS model according to some embodiments of the present invention;

FIG. 5A is a schematic diagram of an S curve according to some embodiments of the present invention;

FIG. 5B is a schematic diagram of a depth estimation image according to some embodiments of the present invention;

FIG. 5C is a schematic diagram of a target image according to some embodiments of the present invention;

FIG. 6 is a block diagram of a light distribution generation module according to some embodiments of the present invention;

FIG. 7A is a block diagram of a dimming system according to some embodiments of the present invention;

FIG. 7B is a block diagram of a dimming system according to some embodiments of the present invention;

FIG. 8 is a schematic block diagram of a system of an electronic device according to some embodiments of the present invention;

FIG. 9 is a flowchart of a training method according to some embodiments of the present invention;

FIG. 10 is a flowchart of a target calculation procedure according to some embodiments of the present invention;

FIG. 11 is a flowchart of adjusting an input image according to some embodiments of the present invention;

FIG. 12 is a flowchart of a dimming method according to some embodiments of the present invention; and

FIG. 13 is a flowchart of a dimming method according to some embodiments of the present invention.

### DETAILED DESCRIPTION

The foregoing and other technical contents, features, and effects of the present invention are clear in the following detailed descriptions of embodiments with reference to the accompanying drawings. Any modification and variation that can be made without departing from the effects and objectives that can be achieved by the present invention still fall within the scope of the technical contents disclosed in the present invention. The same reference numerals in all the figures will be used to represent the same or similar elements.

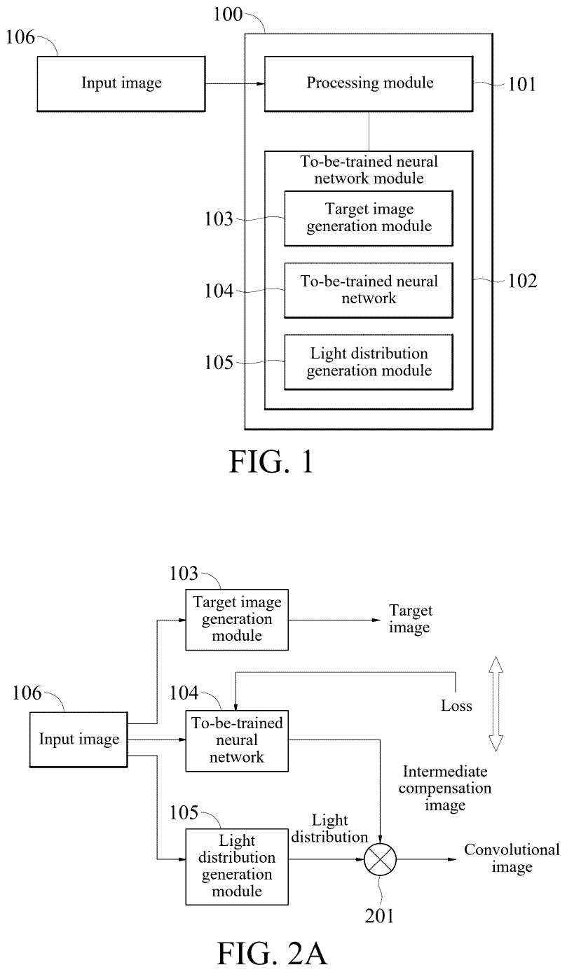

FIG. 1 is a block diagram of a training system according to an embodiment of the present invention. Refer to FIG. 1. The training system 100 includes a processing module 101 and a to-be-trained neural network module 102. The processing module 101 is configured to obtain an input image 106. The to-be-trained neural network module 102 includes a target image generation module 103, a to-be-trained neural network 104, and a light distribution generation module 105.

The target image generation module 103 is configured to receive the input image 106 from the processing module 101 and obtain a target image based on a target calculation procedure. The to-be-trained neural network 104 has a plurality of parameters. The to-be-trained neural network 104 is configured to receive the input image 106 and generate an intermediate compensation image based on the input image 106 and the parameters of the to-be-trained neural network 104. In some embodiments of the present invention, the to-be-trained neural network 104 includes a plurality of convolutional neural networks connected in series. Each of the convolutional neural networks connected in series included in the to-be-trained neural network 104 includes at least one convolution kernel. The parameters of the to-be-trained neural network 104 include a plurality of kernel weights of at least one convolution kernel of each of the convolutional neural networks connected in series.

The light distribution generation module 105 is configured to receive the input image 106 and generate light distribution based on the input image 106. The light distribution is used for approximating intensity distribution of actual backlight. In some embodiments of the present invention, the light distribution is represented by the following formula:

$${I}_{total} ( x , y ) = {\sum }_{i = 1}^{N} {I}_{0 , i} \times exp ( - \frac{{( x - {x}_{0 , i} )}^{2} + {( y - {y}_{o , i} )}^{2}}{2 {σ}^{2}} ) . \qquad ( formula 1 )$$

N is a quantity of LEDs, and Iₜₒₜₐₗ(x,y) is a light intensity at a position of (x,y). σ is a standard deviation of a normal distribution, which determines a diffusion range of the light intensity. I_{0,i} and (x_{0,i},y_{0,i}) are respectively a maximum light intensity and a center position of an i^{th} LED.

The following describes in detail, with reference to the accompanying drawings, a training method and cooperation between modules of the training system 100 according to some embodiments of the present invention.

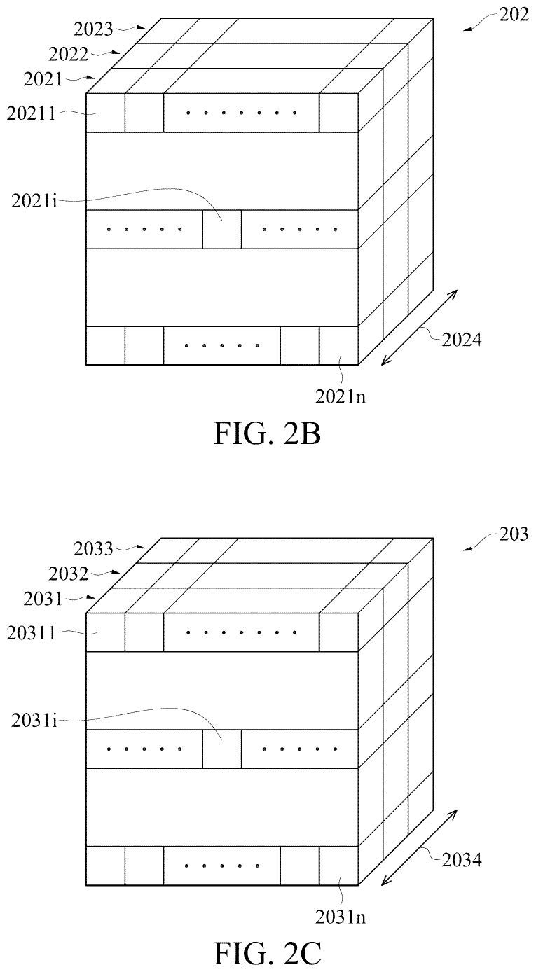

FIG. 2A is a schematic flowchart of a training method according to some embodiments of the present invention. FIG. 9 is a flowchart of a training method according to some embodiments of the present invention. Refer to FIG. 1, FIG. 2A, and FIG. 9 together. In some embodiments of the present invention, the training method includes performing step S901 and step S902 by the processing module 101 in one training epoch. Step S901: The processing module 101 repeatedly performs the following operations: using a training image in a training set as the input image 106, and respectively inputting the input image 106 to the target image generation module 103, the to-be-trained neural network 104, and the light distribution generation module 105 to obtain the target image generated by the target image generation module 103, the intermediate compensation image output by the to-be-trained neural network 104, and the light distribution generated by the light distribution generation module 105. The processing module 101 performs a convolution operation on the intermediate compensation image and the light distribution through a convolution module 201, to generate a convolutional image. The processing module 101 then obtains a loss based on the convolutional image and the target image.

The processing module 101 obtains a plurality of losses after all training images in the training set that are predetermined to be input to the target image generation module 103, the to-be-trained neural network 104, and the light distribution generation module 105 are input, where each loss corresponds to one input image. Step S902: The processing module 101 updates the parameters of the to-be-trained neural network 104 based on an average of all the losses obtained in step S901 and an updated algorithm used by the processing module 101.

In some embodiments of the present invention, the processing module 101 uses a mean square error between the convolutional image and the target image as the loss. The using the mean square error between the images as a loss is referred to as using the mean square error.

FIG. 2B is a schematic diagram of a convolutional image according to some embodiments of the present invention. FIG. 2C is a schematic diagram of a target image according to some embodiments of the present invention. Refer to FIG. 2A to FIG. 2C together. In some embodiments of the present invention, the convolutional image is shown as a tensor 202, and the target image is shown as a tensor 203. The tensor 202 includes elements 2021 to 2023 along a channel axis 2024. The elements 2021 to 2023 respectively correspond to a red channel, a green channel, and a blue channel of the convolutional image. The convolutional image has n pixels (that is, the elements 2021 to 2023 each have n elements). The n pixels of the convolutional image are numbered 1 to n. For each pixel of the convolutional image, the elements 2021 to 2023 each have a corresponding element. For example, for the pixel at the upper left corner of the convolutional image numbered 1, the corresponding element in the element 2021 is element 20211; for the pixel at the lower right corner of the convolutional image numbered n, the corresponding element in the element 2021 is element 2021n; and for the pixel in the convolutional image numbered i, the corresponding element in the element 2021 is element 2021i.

The tensor 203 includes elements 2031 to 2033 along a channel axis 2034. The elements 2031 to 2033 respectively correspond to a red channel, a green channel, and a blue channel of the target image. The target image has n pixels (that is, the elements 2031 to 2033 each have n elements). The n pixels of the target image are numbered 1 to n corresponding to the numbers for the convolutional image. For each pixel of the target image, the elements 2031 to 2033 each have a corresponding element. For example, for the pixel at the upper left corner of the target image numbered 1 corresponding to the number for the convolutional image, the corresponding element in the element 2031 is element 20311; for the element at the lower right corner of the target image numbered n corresponding to the number for the convolutional image, the corresponding element in the element 2031 is element 2031n; and for the pixel in the target image numbered i, the corresponding element in the element 2031 is element 2031i.

In this embodiment, the mean square error between the convolutional image and the target image can be represented by the following formula:

$$Mean square error = \frac{1}{n \times 3} {\sum }_{c ∈ ( R , G , B )} {\sum }_{i = 1}^{n} {( {y}_{i , c} - {\hat{y}}_{i , c} )}^{2}$$

y_{i,c} is a value of an i^{th} pixel of the convolutional image on a channel c, ŷ_{i,c} is a value of an i^{th} pixel of the target image on a channel c, R represents the red channel, G represents the green channel, and B represents the blue channel. For example, when the channel c is the red channel, y_{i,c} is the value of the element 2021i of the element 2021, and ŷ_{i,c} is the value of the element 2031i of the element 2031.

It should be noted that, a numbering order of the n pixels of the convolutional image does not affect calculation of the aforementioned mean square error.

The foregoing updated algorithm may be one of a gradient descent (GD) algorithm, a stochastic gradient descent (SGD) algorithm, a momentum algorithm, an RMSProp method, an Adagrad method, and an adaptive moment estimation (Adam) method, or may be other updated algorithm. The present invention does not set limitation on what updating algorithm to use.

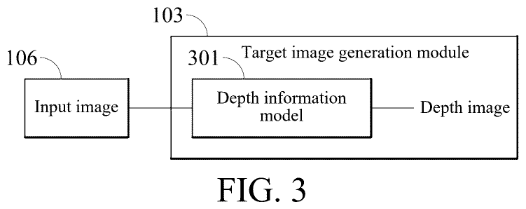

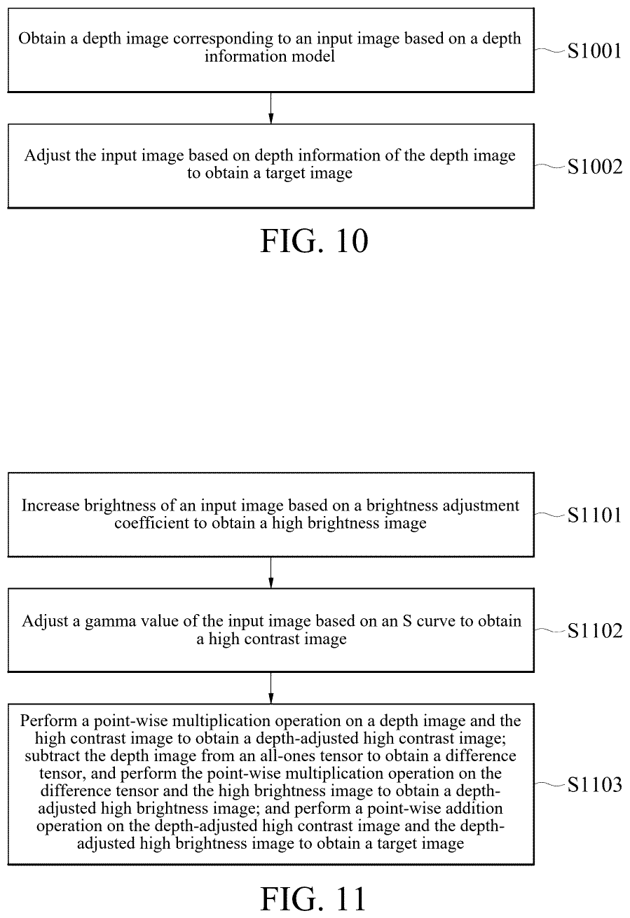

FIG. 3 is a block diagram of a target image generation module according to some embodiments of the present invention. FIG. 10 is a flowchart of a target calculation procedure according to some embodiments of the present invention. Refer to FIG. 3 and FIG. 10 together. In some embodiments of the present invention, the target image generation module 103 generates the target image with a 3D-like effect by using a depth image of the input image 106. In this embodiment, the target image generation module 103 includes a depth information model 301. The depth information model 301 is configured to obtain the depth image of the input image 106. A value of each pixel of the depth image (which is referred to as a depth value of each pixel of the depth image below for ease of description) represents a relative depth estimation value of a corresponding pixel of the input image. In this embodiment, the depth value of each pixel of the depth image is set to fall within an interval [0, 1], and a smaller depth value of a pixel of the depth image indicates a lower depth (namely, a shorter estimated distance from lens). The depth value of the pixel of the depth image represents depth information of the depth image.

In this embodiment, the foregoing target calculation procedure includes step S1001 and step S1002. Step S1001: The target image generation module 103 obtains the depth image corresponding to the input image 106 based on the depth information model 301. Step S1002: The target image generation module 103 adjusts the input image 106 based on the depth information of the depth image, to obtain the target image.

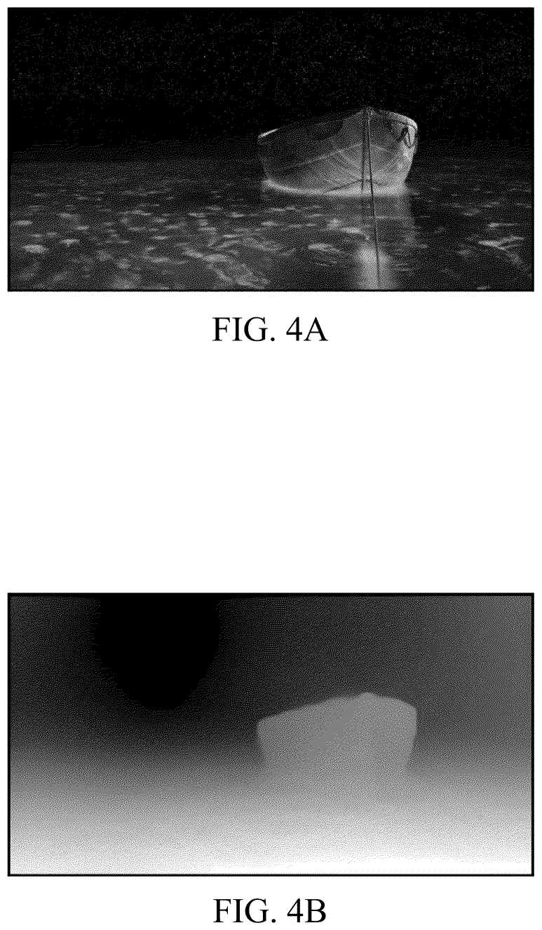

FIG. 4A and FIG. 4B are schematic diagrams of an input image and an output image of a MiDaS model according to some embodiments of the present invention. Refer to FIG. 4A and FIG. 4B together. In some embodiments of the present invention, the depth information model 301 includes a MiDaS model. The MiDaS model may calculate a relative inverse depth based on a single image. To be specific, a larger value of a pixel of a depth estimation image output by the MiDaS model indicates a lower depth (namely, a shorter estimated distance from the lens). For example, if FIG. 4A is used as an input of the MiDaS model and the depth estimation image output by the MiDaS model is represented in a gray scale manner, FIG. 4B may be obtained. Because a larger value of a pixel of the depth estimation image output by the MiDaS model indicates a lower depth, it can be learned that a brighter part in FIG. 4B indicates a lower depth (namely, a shorter estimated distance from the lens).

In this embodiment, after the depth information model 301 obtains the depth estimation image DepthMap corresponding to the input image 106 based on an output of the MiDaS model, the depth information model 301 obtains a maximum value max(DepthMap) of a pixel of the depth estimation image DepthMap and a minimum value min(DepthMap) of a pixel of the depth estimation image DepthMap. The depth information model 301 subtracts the minimum value min(DepthMap) of the pixel of the depth estimation image DepthMap from a value of each pixel of the depth estimation image DepthMap, and then multiplies the difference by

$$\frac{1}{max ( DepthMap ) - min ( DepthMap )}$$

to obtain an intermediate depth image DepthMapᵢₙₜₑᵣ of the input image 106. The depth information model 301 then subtracts the intermediate depth image DepthMapᵢₙₜₑᵣ from an all-ones tensor (namely, a tensor in which all element values are 1) to obtain the depth image of the input image 106. In this case, a depth value of each pixel of the depth image of the input image 106 falls within the interval [0, 1], and a smaller depth value of a pixel of the depth image indicates a lower depth (namely, a shorter estimated distance from the lens).

It should be noted that, in the foregoing embodiments, the depth information model 301 is configured to use the MiDaS model. Certainly, the depth information model 301 may alternatively be configured to use another monocular depth estimation model. For example, the monocular depth estimation model may be a deep ordinal regression network (DORN), a DenseDepth, a dense prediction transformer (DPT), a global-local path network (GLPN), or a Marigold. This is not limited in the present invention. The DORN and the DenseDepth are models established based on a convolution neural network, the DPT and the GLPN are transformer-based models, and the Marigold is a diffusion-based model.

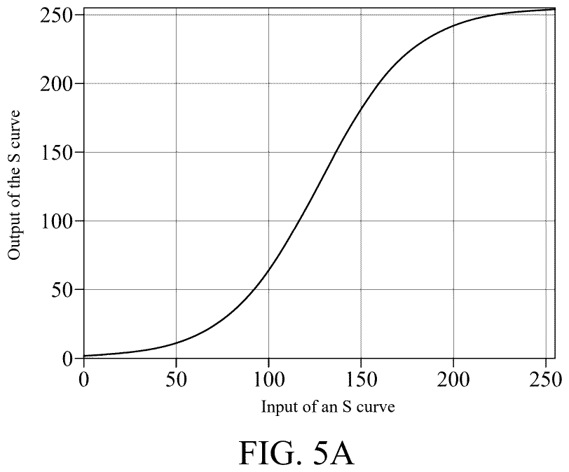

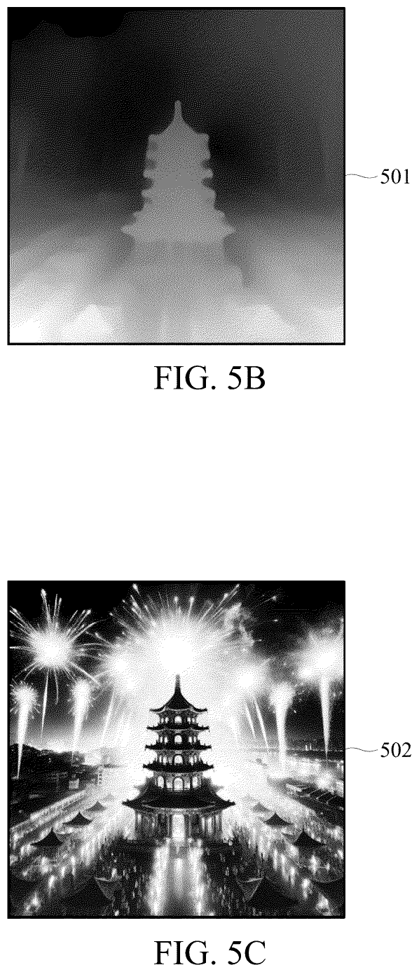

FIG. 5A is a schematic diagram of an S curve according to some embodiments of the present invention. FIG. 5B is a schematic diagram of a depth estimation image according to some embodiments of the present invention; FIG. 5C is a schematic diagram of a target image according to some embodiments of the present invention; FIG. 11 is a flowchart of adjusting an input image according to some embodiments of the present invention. Refer to FIG. 5A and FIG. 11 together. In some embodiments of the present invention, step S1002 includes step S1101 to step S1103.

Step S1101: The target image generation module 103 increases brightness of the input image 106 based on a brightness adjustment coefficient δ, to obtain a high brightness image. In some embodiments of the present invention, the target image generation module 103 adds the brightness adjustment coefficient δ to a pixel value of each pixel of the input image 106, to obtain the high brightness image HighBrightnessImage. In other words, if I represents the input image 106 and I′ represents an input image, for all pixel positions (x,y), I′(x,y)=I(x,y)+δ. When I is a gray image, I(x,y) is a scalar. When I is a color image, I(x,y) is a vector including three components corresponding to R, G, and B. In this case, I(x,y)+δ means adding δ to each of the three components of I(x,y).

Step S1102: The target image generation module 103 adjusts a gamma value of the input image 106 based on an S curve (for example, an S curve shown in FIG. 5A), to obtain a high contrast image HighContrastImage. In some embodiments of the present invention, the target image generation module 103 first converts the input image 106 to a YCC color space, changes the gamma value of the input image 106 based on the S curve (for example, the S curve shown in FIG. 5A), and then converts the input image 106 to an RGB format to obtain the high contrast image HighContrastImage.

Step S1103: The target image generation module 103 performs a point-wise multiplication operation on the depth image and the high contrast image HighContrastImage to obtain a depth-adjusted high contrast image HighContrastImage′. The depth image is subtracted from an all-ones tensor (that is, a tensor whose all values are 1) to obtain a difference tensor (the subtraction operation is a point-wise subtraction operation), and the point-wise multiplication operation is performed on the difference tensor and the high brightness image HighBrightnessImage, to obtain a depth-adjusted high brightness image HighBrightnessImage′; and a point-wise addition operation is performed on the depth-adjusted high contrast image HighContrastImage′ and the depth-adjusted high brightness image HighBrightnessImage′ to obtain the target image.

If Iₒₙₑₛ represents the all-ones tensor, T_{image} represents the target image, and Depth represents the depth image, for all pixel positions (x,y), the following relation expression may be obtained:

$$image ( x , y ) = Depth ( x , y ) * HighContrastImage ( x , y ) + ( {I}_{ones} ( x , y ) - Depth ( x , y ) ) * HighBrightnessImage ( x , y ) = {HighContrastImage}^{′} ( x , y ) + {HighBrightnessImage}^{′} ( x , y )$$

When the high contrast image HighContrastImage and the high brightness image HighBrightnessImage are grayscale images, HighContrastImage(x,y) and HighBrightnessImage(x,y) are scalars. When the high contrast image HighContrastImage and the high brightness image HighBrightnessImage are color images, HighContrastImage(x,y) and HighBrightnessImage(x,y) are vectors, where each vector includes three components of R, G, and B. In this case, Depth(x,y)*HighContrastImage(x,y) means multiplying each of the three components of HighContrastImage(x,y) by Depth(x,y), and (Iₒₙₑₛ(x,y)−Depth(x,y))*HighBrightnessImage(x,y) means multiplying each of the three components of HighBrightnessImage(x,y) by Iₒₙₑₛ(x,y)−Depth(x,y).

Refer to FIG. 5B and FIG. 5C together. In some embodiments of the present invention, the depth information model 301 obtains a depth estimation image 501 corresponding to the input image 106 based on an output of the MiDaS model, and obtains the depth image of the input image 106 based on the depth estimation image 501. The target image generation module 103 then obtains a target image 502 with a 3D-like effect through step S1101 to step S1103.

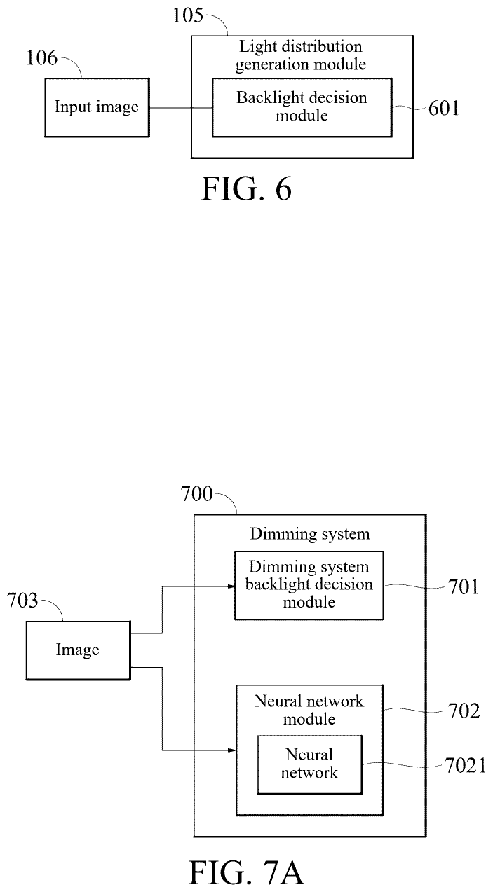

FIG. 6 is a block diagram of a light distribution generation module according to some embodiments of the present invention. Refer to FIG. 6. In some embodiments of the present invention, the light distribution generation module 105 includes a backlight decision module 601. The backlight decision module 601 is configured to receive the input image 106 and generate a plurality of backlight source intensities based on the input image 106. The light distribution generation module 105 is configured to generate light distribution based on the backlight source intensities.

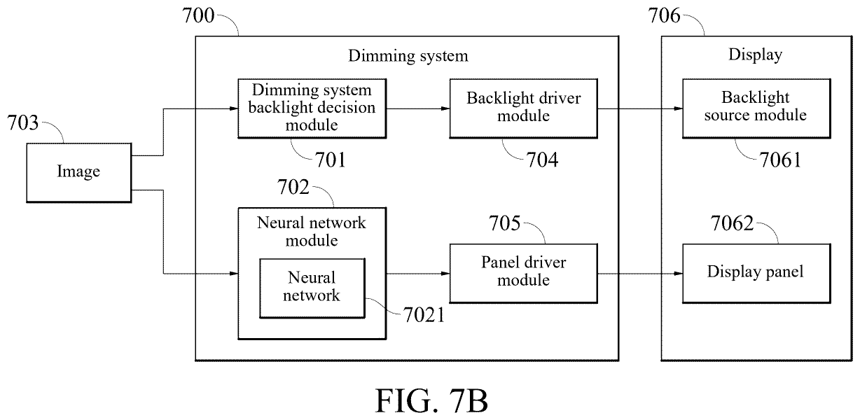

FIG. 7A is a block diagram of a dimming system according to some embodiments of the present invention. Refer to FIG. 7A. The dimming system 700 includes a dimming system backlight decision module 701 and a neural network module 702. The dimming system backlight decision module 701 is configured to receive a to-be-displayed image 703 and generate a plurality of backlight source intensities of the image 703 based on the image 703. In some embodiments of the present invention, the dimming system backlight decision module 701 and the backlight decision module 601 have a same decision result. In other words, the dimming system backlight decision module 701 and the backlight decision module 601 generate a plurality of identical backlight source intensities for a same image.

The neural network module 702 includes a neural network 7021. The neural network 7021 has a same architecture as the to-be-trained neural network 104. The neural network module 702 is configured to receive and store a plurality of parameters of the to-be-trained neural network 104 obtained from the completion of training by the aforementioned training system 100. When the image 703 is input to the neural network module 702, the neural network module 702 generates a compensation image of the image 703 based on the neural network 7021 and the stored parameters.

The following describes in detail, with reference to the accompanying drawings, a dimming method and cooperation between modules of the dimming system 700 according to some embodiments of the present invention.

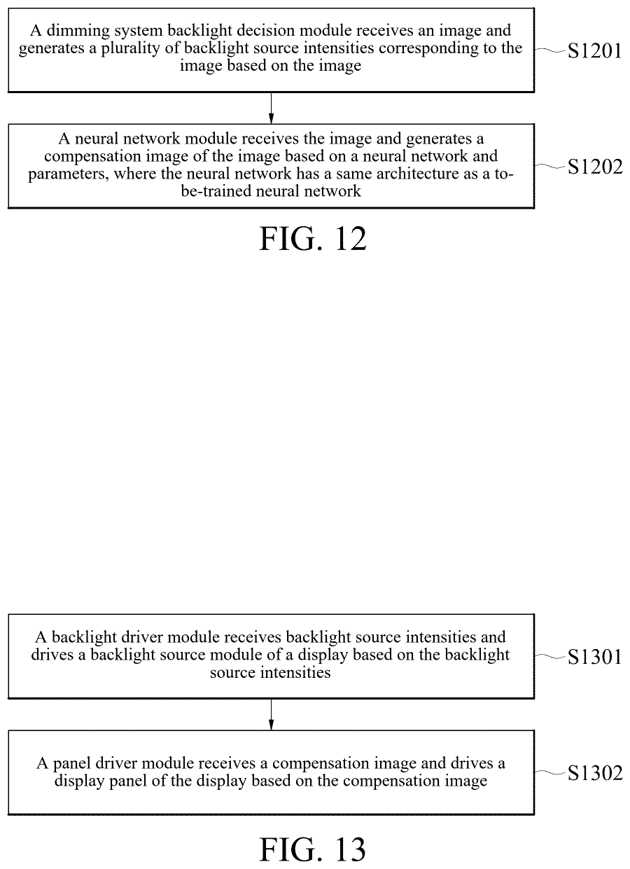

FIG. 12 is a flowchart of a dimming method according to some embodiments of the present invention. Refer to FIG. 7A and FIG. 12 together. In the embodiments shown in FIG. 12, the dimming method includes step S1201 and step S1202. Step S1201: The dimming system backlight decision module 701 receives the to-be-displayed image 703 and generates the plurality of backlight source intensities corresponding to the image 703 based on the image 703. Step S1202: The neural network module 702 receives the image 703 and generates the compensation image of the image 703 based on the neural network 7021 included in the neural network module 702 and the received parameters that are obtained from the completion of training by the training system 100.

FIG. 7B is a block diagram of a dimming system according to some embodiments of the present invention. FIG. 13 is a flowchart of a dimming method according to some embodiments of the present invention. Refer to FIG. 7B. In the embodiments shown in FIG. 7B, the dimming system 700 includes a backlight driver module 704 and a panel driver module 705. The backlight driver module 704 is configured to receive the backlight source intensities that correspond to the image 703 and that are generated by the dimming system backlight decision module 701, and drive a backlight source module 7061 of a display 706 based on the backlight source intensities. The panel driver module 705 is configured to receive the compensation image generated by the neural network module 702 and drive a display panel 7062 of the display 706 based on the compensation image. In this embodiment, the dimming method includes step S1301 and step S1302 after step S1201 and step S1202. Step S1301: The backlight driver module 704 receives the backlight source intensities and drives the backlight source module 7061 of the display 706 based on the backlight source intensities. Step S1302: The panel driver module 705 receives the compensation image and drives the display panel 7062 of the display 706 based on the compensation image.

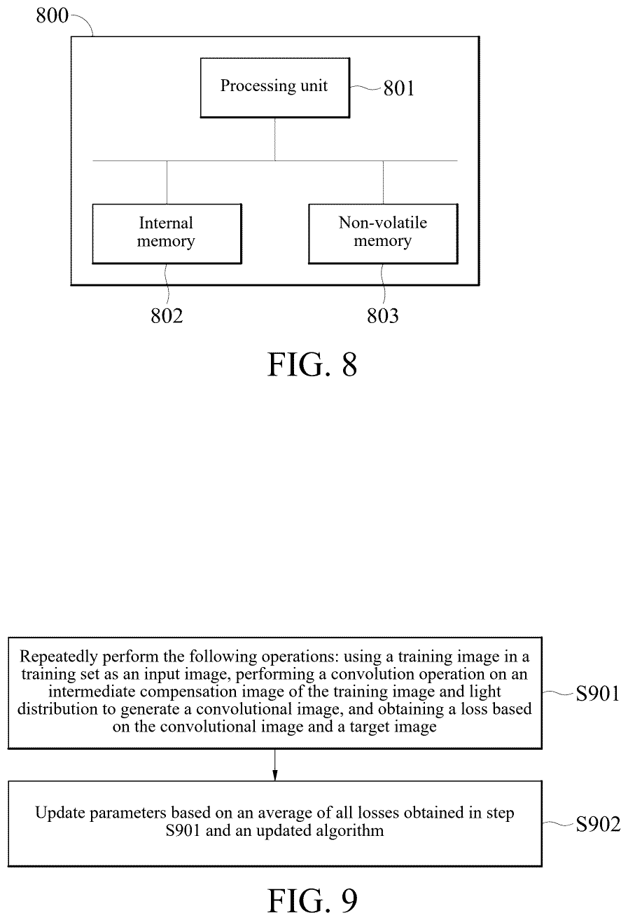

FIG. 8 is a schematic block diagram of a system of an electronic device according to some embodiments of the present invention. As shown in FIG. 8, in terms of hardware, the electronic device 800 includes a processing unit 801, an internal memory 802, and a non-volatile memory 803. For example, the internal memory 802 is a random access memory (Random-Access Memory, RAM). For example, the non-volatile memory 803 is at least one magnetic disk memory. Certainly, the electronic device 800 may further include hardware required for other functions.

The internal memory 802 and the non-volatile memory 803 are configured to store programs. The programs may include program code, and the program code includes computer operation instructions. The internal memory 802 and the non-volatile memory 803 provide instructions and data to the processing unit 801. The processing unit 801 reads a corresponding computer program from the non-volatile memory 803 to the internal memory 802 for execution, to logically form the training system 100 or the dimming system 700.

The processing unit 801 may be an integrated circuit chip having a signal processing capability. In an implementation process, the methods and steps disclosed in the foregoing embodiments may be implemented by using an integrated logic circuit or instructions in a form of software in the processing unit 801. The processing unit 801 may be a general-purpose processor, including a central processing unit, a digital signal processor, an application specific integrated circuit, a field programmable gate array, or another programmable logic device, and may implement or perform the methods and steps disclosed in the foregoing embodiments.

An embodiment of this specification further provides a computer-readable storage medium. The computer-readable storage medium stores at least one instruction. When the at least one instruction is executed by the processing unit 801 of the electronic device 800, the processing unit 801 of the electronic device 800 is enabled to perform the methods and steps disclosed in the foregoing embodiments.

Examples of the storage medium of the computer include, but are not limited to, a phase change memory (PRAM), a static random-access memory (SRAM), a dynamic random access memory (DRAM), another type of random access memory (RAM), a read-only memory (ROM), an electrically-erasable programmable read-only memory (EEPROM), a flash memory or another internal memory technology, a compact disk read-only memory (CD-ROM), a digital versatile disc (DVD) or another optical memory, a cassette magnetic tape, a magnetic tape disk memory or another magnetic storage device, or any other non-transmission medium. The storage medium of the computer may be used to store information that can be accessed by a computing device. As defined in this specification, the computer-readable medium does not include transitory media, such as a modulated data signal or a carrier.

According to the training system, the training method, the dimming system, the dimming method, the computer-readable recording medium with a stored program, and the non-transitory computer program product provided in the foregoing embodiments, the loss obtained based on the convolutional image and the target image is considered in a model training process, so that an image generated by a trained neural network has a desired effect (for example, a 3D-like depth-of-field effect) when being displayed on a display. Using the neural network to generate a compensation image in the dimming system can also make a compensation process faster.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A training system, comprising a processing module and a to-be-trained neural network module, wherein the to-be-trained neural network module comprises:
a target image generation module, configured to receive an input image and obtain a target image based on a target calculation procedure;
a to-be-trained neural network having a plurality of parameters, and the to-be-trained neural network being configured to generate an intermediate compensation image based on the input image and the parameters; and
a light distribution generation module, configured to generate light distribution based on the input image; and
the processing module is configured to perform the following steps in one training epoch:
(a) repeatedly performing the following operations: using a training image in a training set as the input image; performing a convolution operation on the intermediate compensation image of the training image and the light distribution to generate a convolutional image; and obtaining a loss based on the convolutional image and the target image; and
(b) updating the parameters based on an average of all losses obtained in step (a) and an updated algorithm.

2. The training system according to claim 1, wherein the target image generation module comprises a depth information model, and the target calculation procedure comprises: (c) obtaining a depth image corresponding to the input image based on the depth information model;
and (d) adjusting the input image based on depth information of the depth image to obtain the target image.

3. The training system according to claim 2, wherein step (d) comprises:
(d1) increasing brightness of the input image based on a brightness adjustment coefficient to obtain a high brightness image;
(d2) adjusting a gamma value of the input image based on an S curve to obtain a high contrast image; and
(d3) performing a point-wise multiplication operation on the depth image and the high contrast image to obtain a depth-adjusted high contrast image; subtracting the depth image from an all-ones tensor to obtain a difference tensor, and performing the point-wise multiplication operation on the difference tensor and the high brightness image to obtain a depth-adjusted high brightness image; and performing a point-wise addition operation on the depth-adjusted high contrast image and the depth-adjusted high brightness image to obtain the target image.

4. The training system according to claim 2, wherein the depth information model comprises a MiDaS model.

5. The training system according to claim 1, wherein a mean square error is used as the loss.

6. The training system according to claim 1, wherein the light distribution generation module comprises a backlight decision module, the backlight decision module is configured to receive the input image and generate a plurality of backlight source intensities based on the input image, and the light distribution generation module is configured to generate the light distribution based on the backlight source intensities.

7. A dimming system using the parameters trained by the training system according to claim 1, comprising:
a dimming system backlight decision module, configured to receive an image and generate a plurality of backlight source intensities of the image based on the image; and
a neural network module, comprising a neural network, wherein the neural network is configured to have a same architecture as the to-be-trained neural network, and the neural network module is configured to store the parameters and is configured to receive the image and generate a compensation image of the image based on the neural network and the parameters.

8. The dimming system according to claim 12, wherein the dimming system comprises:
a backlight driver module, configured to receive the backlight source intensities and drive a backlight source module of a display based on the backlight source intensities; and
a panel driver module, configured to receive the compensation image and drive a display panel of the display based on the compensation image.

9. A training method, used for training a to-be-trained neural network module and performed by a processing module, wherein the to-be-trained neural network module comprises: a target image generation module, configured to receive an input image and obtain a target image based on a target calculation procedure; a to-be-trained neural network having a plurality of parameters, and the to-be-trained neural network being configured to generate an intermediate compensation image based on the input image and the parameters; and a light distribution generation module, configured to generate light distribution based on the input image, and the training method comprises performing the following steps in one training epoch:
(a) repeatedly performing the following operations: using a training image in a training set as the input image; performing a convolution operation on the intermediate compensation image of the training image and the light distribution to generate a convolutional image; and obtaining a loss based on the convolutional image and the target image; and
(b) updating the parameters based on an average of all losses obtained in step (a) and an updated algorithm.

10. The training method according to claim 7, wherein the target image generation module comprises a depth information model, and the target calculation procedure comprises: (c) obtaining a depth image corresponding to the input image based on the depth information model; and (d) adjusting the input image based on depth information of the depth image to obtain the target image.

11. The training method according to claim 8, wherein step (d) comprises:
(d1) increasing brightness of the input image based on a brightness adjustment coefficient to obtain a high brightness image;
(d2) adjusting a gamma value of the input image based on an S curve to obtain a high contrast image; and
(d3) performing a point-wise multiplication operation on the depth image and the high contrast image to obtain a depth-adjusted high contrast image; subtracting the depth image from an all-ones tensor to obtain a difference tensor, and performing the point-wise multiplication operation on the difference tensor and the high brightness image to obtain a depth-adjusted high brightness image; and performing a point-wise addition operation on the depth-adjusted high contrast image and the depth-adjusted high brightness image to obtain the target image.

12. The training method according to claim 8, wherein the depth information model comprises a MiDaS model.

13. The training method according to claim 7, wherein a mean square error is used as the loss.

14. A dimming method using the parameters trained by the training method according to claim 9, comprising:
receiving an image and generating a plurality of backlight source intensities of the image based on the image by a dimming system backlight decision module; and
receiving the image and generating a compensation image of the image based on a neural network and the parameters by a neural network module, wherein the neural network has a same architecture as the to-be-trained neural network.

15. The dimming method according to claim 14, wherein the dimming method comprises:
receiving the backlight source intensities and driving a backlight source module of a display based on the backlight source intensities by a backlight driver module; and
receiving the compensation image and driving a display panel of the display based on the compensation image by a panel driver module.

16. A non-transitory computer-readable recording medium with a stored program, wherein after the stored program is loaded and executed by a processing unit, the method according to claim 9 is completed.

17. A non-transitory computer-readable program product, storing at least one instruction, wherein when the at least one instruction is executed by a processing unit, the processing unit is enabled to perform the method according to claim 9.
